(19) United States
(12) Patent Application Publication
(10) Pub. No.: US 2004/0207997 A1
(43) Pub. Date: Oct. 21, 2004

(54) Edge-illuminating pyramid

(76) Inventors: Jay Duncan Stewart, Kelowna (CA); Michael Howard Boudreau, Salmon Arm (CA)

Correspondence Address: ANTONY C. EDWARDS, SUITE 800 - 1708 DOLPHIN AVENUE, KELOWNA, BC, V1Y 9S4, CA

(21) Appl. No.: 10/826,394

(22) Filed: Apr. 19, 2004

Related U.S. Application Data
(60) Provisional application No. 60/463,350, filed on Apr. 17, 2003.
(60) Provisional application No. 60/482,492, filed on Jun. 26, 2003.

(51) Int. Cl. F21V 7/04

(52) U.S. Cl. 362/31

(57) ABSTRACT

An edge-illuminated light housing includes a base, a shelf mounted on the base, and a housing mounted on the shelf, wherein a light source in the base illuminates edges of the base and/or housing by internal reflection of the light from the light source through the material of the shelf, housing and/or base. Light emits from the housing and/or base by interruptions in the light path at light diffusing edges.

### CROSS REFERENCE TO RELATED APPLICATION

This application claims priority from U.S. Provisional Patent Application No. 60/463,350 filed Apr. 17, 2003 and U.S. Provisional Patent Application No. 60/482,492 filed Jun. 26, 2003 entitled Edge-Illuminating Pyramid.

### FIELD OF THE INVENTION

This invention relates to the field of decorative light fixtures generally, and in particular to an edge-illuminated light housing such as an edge-illuminating pyramid.

### BACKGROUND OF THE INVENTION

Applicant is aware of U.S. Pat. No. 6,177,761 which issued Jan. 23, 2001 to Pelka et al. Pelka et al disclose efficient extraction of light from solid transparent media, and more particularly by the use of pyramidal structure.

As taught by Pelka et al, light produced inside a high index of refraction material may be trapped by total internal reflection. This is particularly true in a geometry of high symmetry, say a cube or parallelepiped. This poses a problem for light emitting diodes (LED's) where the index of refraction is very high, i.e. greater than three, so that only a small fraction of the light emerges. There is need for a means to enable a very large fraction of the light to emerge from LED associated transmission media, in order to significantly increase the efficiency of light transmission from LED's.

Thus, Pelka et al teach an improved LED light extraction means embodying a pyramidal configuration which includes:

(a) a cylindrical body consisting of light transmitting material, the body having a cylindrical outer wall,

(b) a pyramidal body having at least three planar sides and consisting of light transmitting material, the pyramidal body located longitudinally endwise of the cylindrical body, to expose the three or more sides, the planar sides defining planes which intersect the cylindrical body outer wall at curved edges, the cylindrical outer wall terminating at such curved edges;

(c) LED means located in spaced relation to the pyramidal body, and oriented to transmit light in the cylindrical body and toward the pyramidal body.

### SUMMARY OF THE INVENTION

In the edge-illuminating pyramid of the present invention, light is introduced into sheets of light-transmitting material such as acrylic by reflecting the light off a 45 degree conical mirror mounted in a base under the sheets. The sheets form a pyramid shape. The total internal reflection of each sheet is used to deliver the light from a light source in the base, reflected by the conical mirror and along to the edge of each sheet so as to be directed upwardly through four triangular sheets which may be inclined at approximately 51 degrees (in one example 51 degrees, 51 minutes, 51 seconds), and downwardly through four further sheets defining a frusto-pyramidal base inclined at the same angle as the four sheets defining the upper pyramid, so that the light is carried within all of the sheets by total internal reflection to the joints, interfaces, junctions, corners or vertices between the sheets where a portion of the light escapes to create the above described ornamental lighting effect.

In summary, the present invention may be characterized as an edge-illuminated light housing including a base, a shelf mounted on the base, and a housing mounted on the shelf, wherein a light source in the base illuminates edges of the base and/or housing by internal reflection of the light from the light source through the material of the shelf, housing and/or base. Light emits from the housing and/or base by interruptions in the light path at light diffusing edges. The shelf contains a conical bore in an upper surface thereof. The conical bore opens and diverges upwardly so as to form a generally radially uniform substantially forty-five degree light reflective surface. The light source is mounted in the base under the conical bore. The light source directs light upwardly so as to impinge the conical bore. The light is thereby reflected radially outwardly of the conical bore, along and within the shelf.

The shelf has at least one perimeter edge angled at a reflective angle so as to reflect the light travelling along and within the shelf upwardly from the at least one perimeter edge. The housing has light transmissive walls of light transmissive material adapted to internally reflect light. At least one lower edge of the walls is shaped for conformal mating onto the at least one perimeter edge to thereby allow transmission of the light reflected upwardly from the at least one perimeter edge into and along a light path within the walls of the housing. The walls of the housing have light diffusing edges in, and interrupting, the light path so as to diffuse light outwardly of the housing only along the light diffusing edges to thereby define a lit shape as seen by a user substantially transparently supported by the housing.

### BRIEF DESCRIPTION OF THE DRAWINGS

FIG. 1 is, in perspective view, one embodiment of the edge-illuminating pyramid of the present invention.

FIG. 1a is the edge-illuminating pyramid of FIG. 1 with the transparent cover removed.

FIG. 2 is, in plan view, the pyramid of FIG. 1a.

FIG. 3 is, in side elevation view, the base of FIG. 2.

FIG. 4 is, in front perspective view, the base shelf of FIG. 2.

FIG. 4a is, in side elevation cross-sectional view, the base shelf of FIG. 4 along line 4a-4a.

FIG. 4b is the base shelf of FIG. 4 illustrating an enlarged view of one corner.

FIG. 5 is, in plan view, the transparent pyramidal cover of the pyramid of FIG. 1.

FIG. 5a is, in side elevation view, the cover of FIG. 5.

FIG. 5b is, in partially cut away bottom perspective view, the cover of FIG. 5.

FIG. 6 is, in perspective shaded view, the pyramid assembly illustrating the voids in the vertices of the cover.

FIG. 7 is, in hidden line perspective view, the pyramid assembly showing electronics within the base and in particular the light source.

### DETAILED DESCRIPTION OF EMBODIMENTS OF THE INVENTION

As seen in the accompanying Figures in which corresponding parts in each view are denoted by like reference numerals, edge-illuminated pyramid 10 includes a right regular pyramidal cover 12 mounted on a frusto-pyramidal base 14. It is understood however that although in the detailed description as follows reference is solely made to the shape of a right regular pyramid 10, it is expressly intended that the scope of the present invention includes other three-dimensional rectilinear shapes such as shapes formed by non-right or non-regular pyramids, or for example shapes in which cover 12 and base 14 form an obelisk so long as incorporating edge-illuminating as described below.

The upper shelf 16 of base 14 has an upper surface 16a and an opposite lower surface 16b. The perimeter includes sloped edge lower surfaces 16c. Shelf 16 is mounted on to side plates 18a-18d. In the illustrated embodiment, each of side plates 18a-18d are identical. The base 14 may also be formed as a unitary piece. Surfaces 16c coincidentally and conformally match, so as to snugly mate with, the upper edges of 18a-18d. Surfaces 16c are angled such that light reflected along path B will be reflected upwards along path C in cover 12.

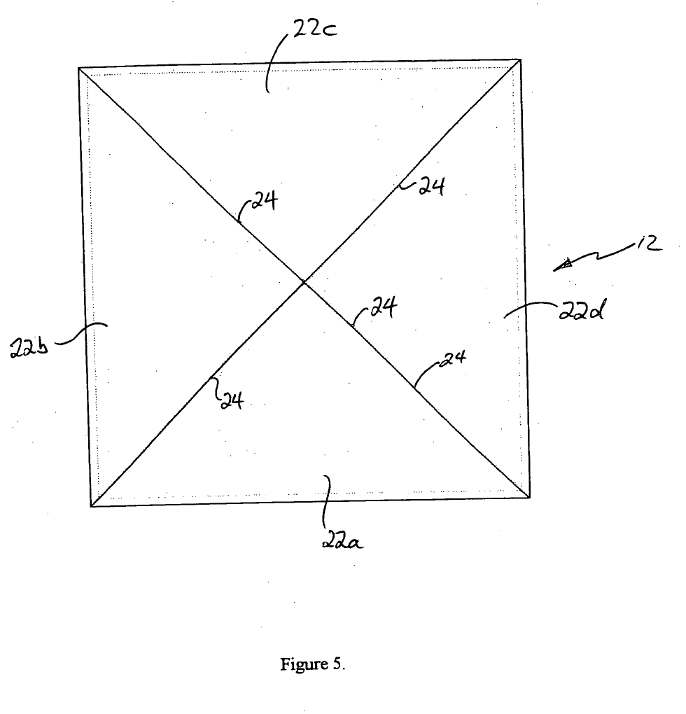

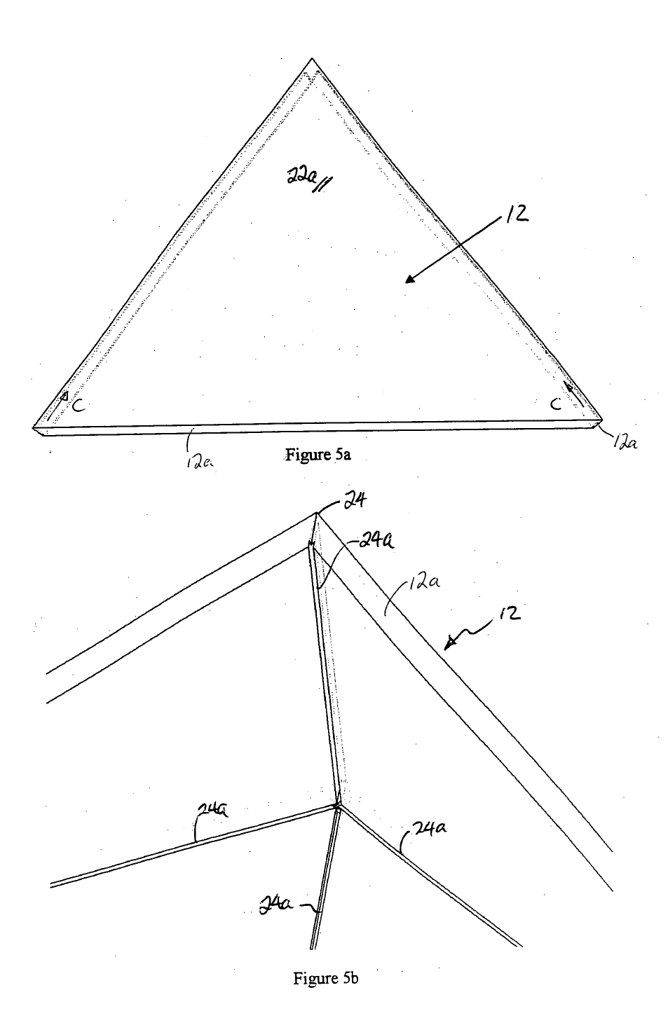

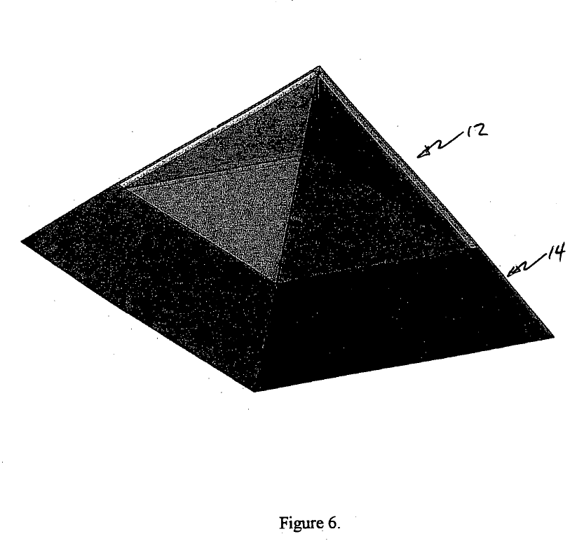

Cover 12, as also seen in FIGS. 5, 5a and 5b, snugly and conformally mounts in a close fit on to shelf 16 on the upwardly angled surfaces of shelf lip 16d formed around the upper perimeter. Cover 12 is formed in one embodiment of transparent triangular plates 22a-22d, each being identical in the illustrated embodiment. The triangular plates form common pyramid vertices 24 which align co-linearly with corresponding corner vertices 26 on base 14. Comer vertices 26 are the common vertices between side plates 18a-18d. Lower edge surfaces 12a of triangular plates 22a-22d are orthogonal to the planes containing the outer or major surfaces of the plates to maximize the acceptance and transference of light following path C, and conformally fits onto shelf lip 16d.

Shelf 16, side plates 18a-18d, and triangular plates 22a-22d and base plate 20 all have a finite plate thickness, for example, and without intending to be limiting, approximately 3 millimetres in the illustrated embodiment. Consequently, the perimeter edges of shelf 16, side plates 18a-18d, and triangular plates 22a-22d, including along vertices 24 and 26, are bevelled or otherwise correspondingly matingly finished for a smoothly abutting fit between the plate elements at lip 16d.

Side plates 18a-18d may be mirrored so as to provide an aesthetic appeal and to hide from view the lighting components contained within base 14 as described herein below. It is understood that the side plates may have other opaque coatings such as paint. The bottom bevelled edge of side plates 18a-18d may be mirrored. None of the bevelled edges are mirrored. In one embodiment, the interior surfaces of side plates 18a-18d are mirror coated so as to reflect outwardly of the otherwise transparent side plates. Advantageously, shelf 16, side plates 18a-18d, and triangular plates 22a-22d are all made of a transparent or other light-conducting rigid material such as acrylic sheet.

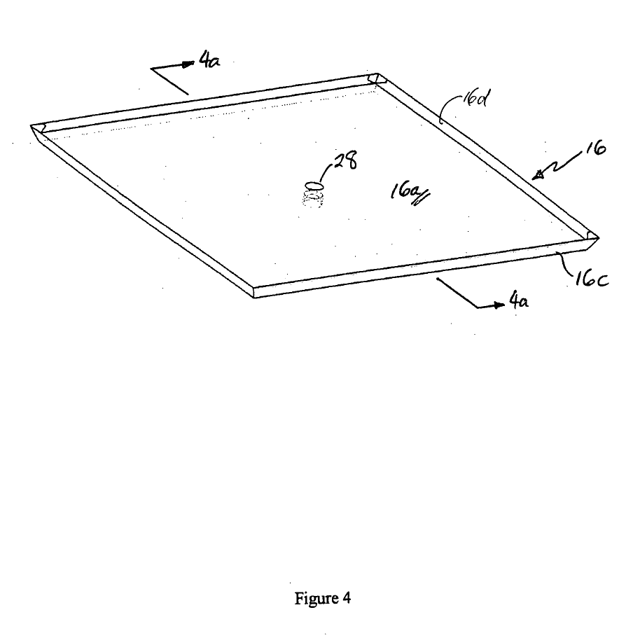

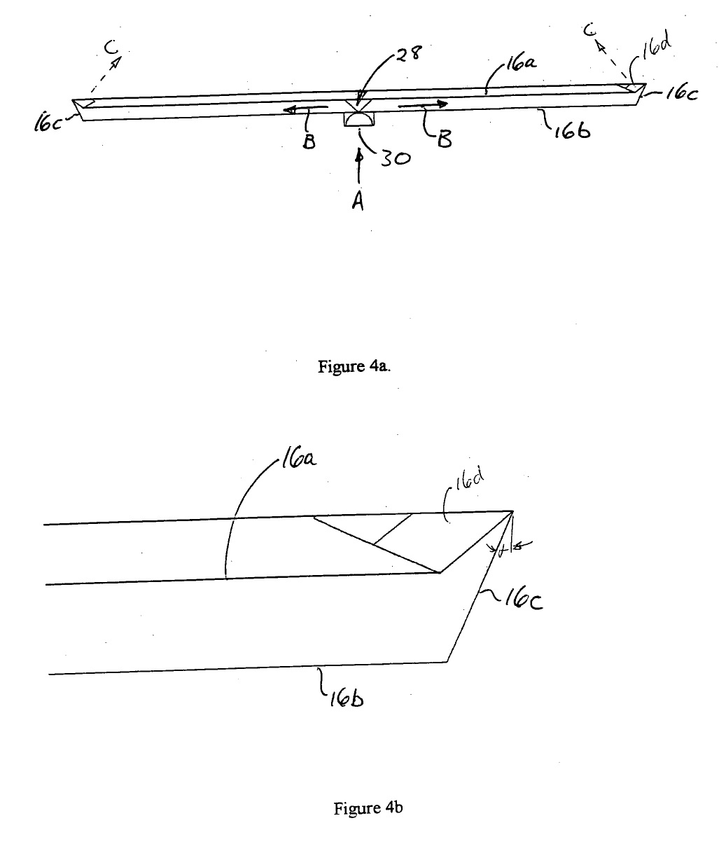

An upwardly opening conical bore 28 is formed in upper surface 16a of shelf 16. Conical bore 28 has an axis of symmetry which is orthogonal to upper surface 16a and may be centrally disposed thereon. Conical bore 28 has an included angle of 90 degrees so as to form 45 degree inclined light reflecting surfaces. Thus conical bore 28 serves as an internally reflective mirror to reflect light directed in direction A into shelf 16 in direction B as better seen in FIG. 4a. Conical bore 28 does not penetrate through to lower surface 16b of shelf 16. Rather, a hemispherical window 30 is formed in lower surface 16b, window 30 having an axis of symmetry coaxial with the axis of symmetry of conical bore 28. Conical bore 28 and window 30 need not contact each other.

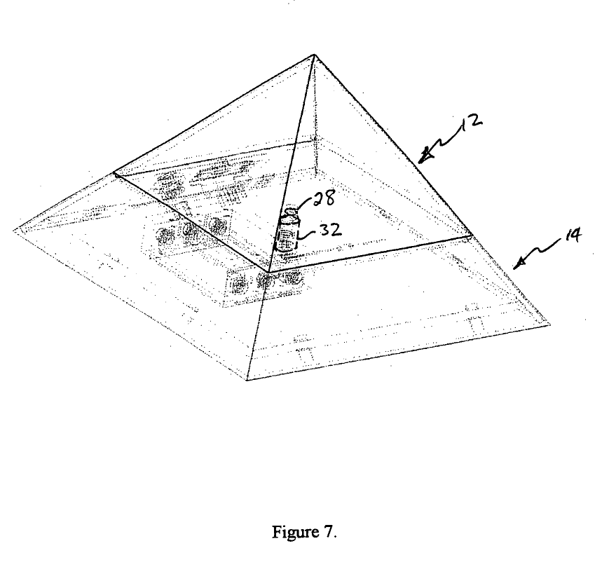

Without intending to be limiting, a light source such as a light emitting diode (LED), a laser diode, or a small lamp, indicated in FIG. 7 as LED 32, is mounted under window 30 so as to direct light from LED 32 in direction A through shelf 16. LED 32 may be a high output blue LED that may be powered by batteries or a/c adaptor (not shown), such an LED requiring for example 30 mA of current at 3 volts.

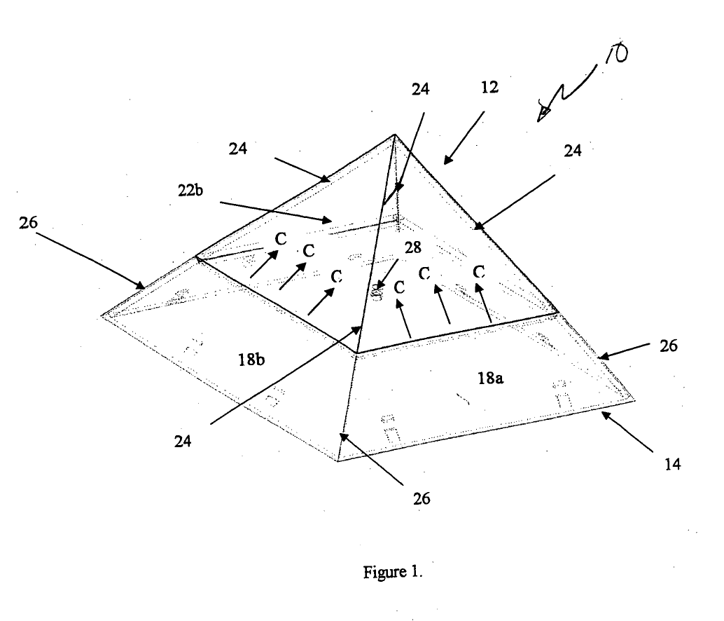

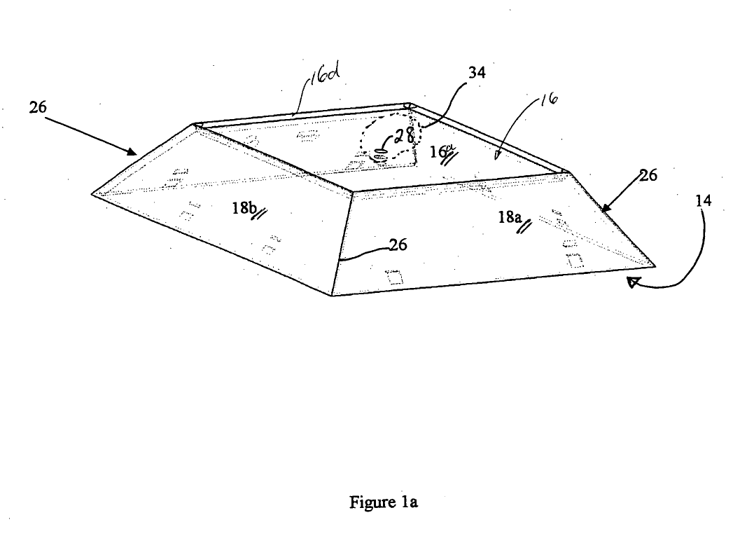

Light in direction A from LED 32 reflects off the 45 degree inclined conical surface of conical bore 28 so as to be dispersed radially outwardly of the axis of symmetry of conical bore 28 in direction B across, and within, shelf 16. With the exception of some of the light in direction A being transmitted through the wall of conical bore 28 so as to emit upwardly of upper surface 16a, the light from LED 32 is reflected in direction B and remains unobservable from the outside of pyramid 10 until the light contacts the perimeter edges 16c of shelf 16. At the interface between edges 16c of shelf 16 and both the lower edges of triangular plates 22a-22d and the upper edges of side plates 18a-18d the majority of the light transmitted in direction B is reflected upwardly through lip 16d in direction C (illustrated in FIG. 1 by discrete arrows but understood to be uniformly distributed) along, and contained within by total internal reflection, triangular plates 22a-22d, and reflected downwardly within side plates 18a-18d, again to remain within the side plates by total internal reflection. As will be understood by one skilled in the art, the total internal reflection of the light within the shelf, the triangular plates, and the side plates, is achieved by light reflected by reason of the angle a formed at the edges 16c of the shelf. The total internal reflection is governed by Brewster's law for the transparent sheets. The light is within the acceptance or Brewster's angle for the transparent sheets of the cover.

Light travelling within the triangular plates and within the side plates is unobservable from the outside of pyramid 10 until the light impinges the gaps or voids 24a at and in the seams of the plates and walls 24 and 26, and along the base edge of base 14. Consequently, due to the use of a conical mirror (conical bore 28) and taking advantage of total internal reflection within the acrylic sheets forming the triangular plates and the side plates, a single light source (LED 32) causes the base edges of pyramid 10, the base edges of cover 12, and the vertices of both cover 12 and base 14, and if desired also the open aperture (if left open) above conical bore 28 to glow while the remainder of the pyramid appears to be unlit. The effect, especially in a dimly lit environment, is one of illuminated bars coinciding with the base edges of cover 12 and base 14 and coinciding with the depth of void 24a at vertices 24 and 26 appearing to define an otherwise transparent pyramid. If a gemstone or other artifact 34 is placed over the aperture above conical bore 28, it too will be lit by light escaping upwardly from conical bore 28 and so appear to be lit and suspended in space within pyramid 10.

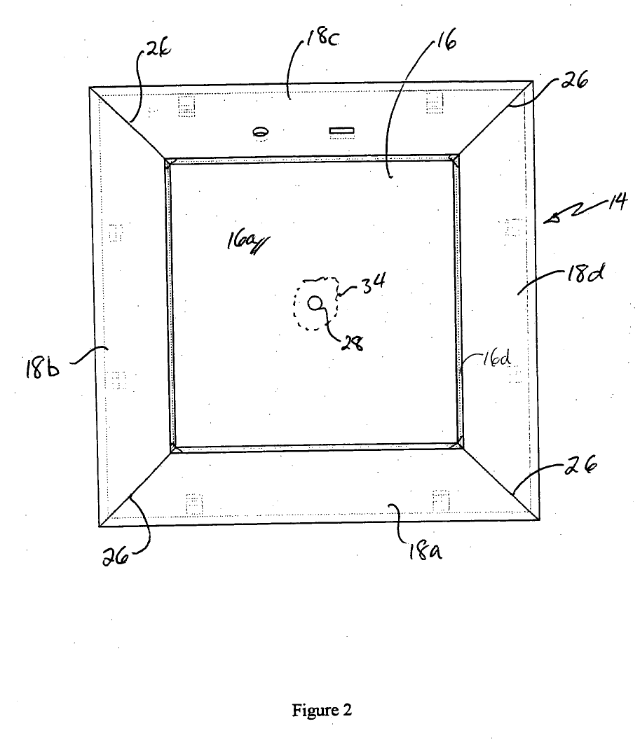

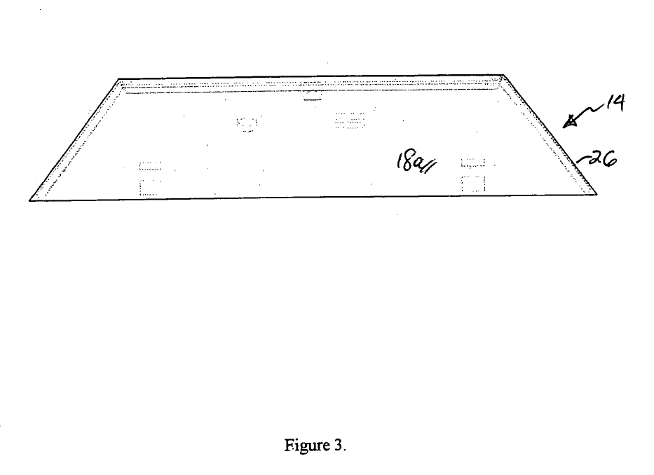

In the example where the pyramid is to serve as an illuminating case for a small artifact 34 (shown in dotted outline in FIG. 1a and FIG. 2), in dimension, cover 12 may measure 4.5 inches on side at its base edge and stand 2.8 inches high, and base 14 may measure 6.75 inches on base edge and stand 1.4 inches high.

In one embodiment, lips 16d may be recesses (as best seen in FIG. 4b) formed on upper surface 16a so as to assist in correct alignment of cover 12 when placed onto shelf 16, and provide more positive means of light transmission from shelf 16 to cover 12.

Again, within shelf 16, the light travels horizontally in direction B within the acrylic sheeting until it reaches edges 16c which have been cut at a specific angle a, for example 26 degrees, to reflect the light back towards the center of the pyramid and up towards the apex of the pyramid resulting in the light travelling up the acrylic sheets making up the sides of cover 12. Additionally, some of the light passing through the reflecting edge of shelf 16 passes down into the mirrored acrylic side plates that make up the sides of base 14. Wherever the light meets a void or edge surface of an acrylic sheet it is reflected like either a mirror or a painted surface, depending on the surface quality and the bonding components used between the surfaces, if any.

In alternative embodiments of the present invention more than one color of light source can be directed through window 30 using an adaptor that funnels multiple light sources down to a single point in the manner of for example a fibre optic bundle, thereby allowing a user to choose which color or color sequence to display on the pyramid.

Light sources can be optionally activated in the pyramid by a manual switch, an infrared motion detector, a sequencing micro-controller, sound (on/off), a music color organ, or remote control (infrared or radio frequency).

In order for infrared light to reach the electronics within the base that activate the light source(s) the mirror needs to allow infrared light to pass through it, while reflecting visible light like a normal mirror does. This is called a cold mirror. Applicants have found that a cold mirror film may be injection moulded into the pieces that need to be mirrored in this manner.

For example, if a user wanted to turn the light on or off by waving the user's hand over the pyramid, the top surface of the mirrored base would be mirrored with a cold mirror and the pyramid would have an infrared motion sensor inside the base looking up through the cold mirror. The cold mirror acts like a two-way mirror letting some of the light through. The light that it is most likely to be let through is infrared light.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. An edge-illuminated light housing comprising:
a base
a shelf mounted on said base, said shelf of light transmissive material adapted to internally reflect light, said shelf containing a conical bore in an upper surface thereof, said conical bore opening and diverging upwardly so as to form a generally radially uniform substantially forty-five degree light reflective surface,
a light source mounted in said base under said conical bore, said light source directing light upwardly so as to impinge said conical bore, said light thereby reflected radially outwardly of said conical bore, along and within said shelf,
said shelf having at least one perimeter edge angled at a reflective angle so as to reflect the light travelling along and within said shelf upwardly from said at least one perimeter edge,
a light transmissive housing mounted on said shelf, said housing having light transmissive walls of light transmissive material adapted to internally reflect light and at least one lower edge of said walls shaped for conformal mating onto said at least one perimeter edge to thereby allow transmission of the light reflected upwardly from said at least one perimeter edge into and along a light path within said walls of said housing,
said walls of said housing having light diffusing edges in, and interrupting, the light path so as to diffuse light outwardly of said housing only along said light diffusing edges to thereby define a lit shape as seen by a user substantially transparently supported by said housing.

2. The device of claim 1 wherein said housing is a pyramid-shape.

3. The device of claim 2 wherein said pyramid is a right regular pyramid.

4. The device of claim 2 wherein said base is a frusto-pyramidal shape.

5. The device of claim 1 wherein said walls and said shelf are of acrylic sheet.

6. The device of claim 1 wherein said reflective angle is substantially twenty-six degrees from the vertical.

7. The device of claim 1 wherein said base also includes walls made of said light transmissive material so as to transmit any light reflected downwardly from said at least one perimeter edge, said walls of said base also having light diffusing edges interrupting a light path of the light reflected from the at least one perimeter edge.

8. The device of claim 7 wherein said walls of said base are mirrored.

9. The device of claim 1 wherein said light source includes a light emitting diode.

10. The device of claim 9 further comprising a light directing window mounted between said conical bore and said light emitting diode.

11. The device of claim 10 wherein said window is a hemispherical dome co-axial with said bore, said dome being domed over so as to open downwardly over said light source.

12. The device of claim 1 wherein said light diffusing edges include gaps between portions of said walls of said housing.

13. The device of claim 1 wherein said walls include planar sheets.

14. The device of claim 13 wherein said light diffusing edges include gaps between said sheets.

15. The device of claim 1 wherein said shelf is planar.

16. The device of claim 15 wherein said shelf includes a light transmissive lip formed over said at least one perimeter edge.

17. The device of claim 16 wherein said lip is defined by a recess formed around said at least one perimeter edge.

18. The device of claim 1 wherein said shelf is adapted to support over said conical bore an artifact to be highlighted by being lit from beneath.

19. The device of claim 18 wherein said artefact is a gemstone.

20. The device of claim 18 wherein said conical bore is positioned substantially in the center of said shelf.
